(19) United States
(12) Patent Application Publication
(10) Pub. No.: US 2019/0113959 A1
(43) Pub. Date: Apr. 18, 2019

(54) POWER CONSUMPTION MANAGEMENT DEVICE AND POWER CONSUMPTION MANAGEMENT METHOD FOR BACKLIGHT MODULE

(71) Applicant: MStar Semiconductor, Inc., Hsinchu Hsien (TW)

(72) Inventor: Neng Chia LEE, Hsinchu Hsien (TW)

(21) Appl. No.: 15/995,196

(22) Filed: Jun. 1, 2018

(30) Foreign Application Priority Data
Oct. 17, 2017 (TW) 106135407

(51) Int. Cl. G06F 1/32; G02F 1/1335; G06K 9/00; H04N 5/232

(52) U.S. Cl. CPC G06F 1/3203; H04N 5/23229; G06K 9/00369; G02F 1/133602

(57) ABSTRACT

A power consumption management method for a backlight module includes receiving an object detection signal from an object detector, controlling an image capturing unit to capture an image according to the object detection signal, receiving the image from the image capturing unit, and controlling a power consumption of the backlight module according to the image.

This application claims the benefit of Taiwan application Serial No. 106135407, filed on Oct. 17, 2017, the subject matter of which is incorporated herein by reference.

### BACKGROUND OF THE INVENTION

### Field of the Invention

The invention relates to a power consumption management device, and more particularly to a power consumption management device for a backlight module.

### Description of the Related Art

With the progressing technologies, liquid-crystal display (LCD) devices are extensively applied to consumer electronic products such as cell phones, laptop computers, tablet computers and television. However, as an LCD panel of an LCD device does not emit light on its own, a backlight module needs to be provided below the LCD panel so as to provide a light source needed by the LCD device for display.

For an LCD device, the power consumption of a backlight module is a main source of the total power consumption of the LCD device. However, with the increasing resolution of display devices, the power consumption of a backlight module accordingly increases. Therefore, there is a need for a solution for appropriately managing the power consumption of a backlight module in the related field.

### SUMMARY OF THE INVENTION

It is an object of the present invention to provide a power consumption management device for a backlight module.

The present invention discloses a power consumption management device for a backlight module. The power consumption management device includes one or more processors, and a memory storing an instruction. When the instruction is executed by the one or more processors, the one or more processors control the power consumption management device to receive an object detection signal from an object detector, controls an image capturing unit to capture an image according to the object detection signal, receives the image from the image capturing unit, and controls a power consumption of the backlight module according to the image.

The present invention further discloses a power consumption management method for a backlight module. The power consumption management method includes receiving an object detection signal from an object detector, controlling an image capturing unit to capture an image according to the object detection signal, receiving the image from the image capturing unit, and controlling a power consumption of the backlight module according to the image.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a block diagram of a power consumption management device for a backlight module according to an embodiment of the present invention;

FIG. 2 is a flowchart of a power consumption management method for a backlight module according to an embodiment of the present invention;

FIG. 3 is a detailed flowchart of a power consumption management method for a backlight module according to an embodiment of the present invention; and

FIG. 4 is a detailed flowchart of a power consumption management method for a backlight module according to an embodiment of the present invention.

### DETAILED DESCRIPTION OF THE INVENTION

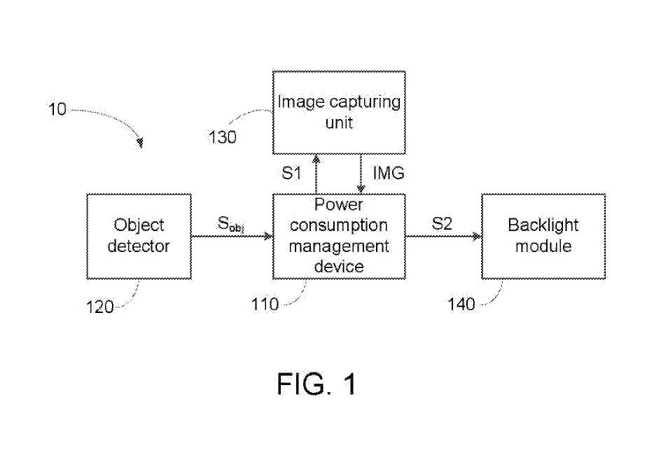

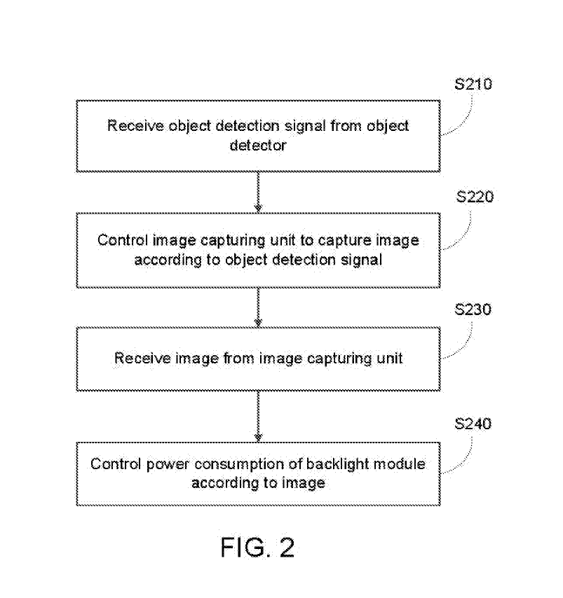

FIG. 1 shows a block diagram of a display device 10 according to an embodiment of the present invention. The display device 10 includes a power consumption management device 110, an object detector 120, an image capturing unit 130 and a backlight module 140. The backlight module 140 may provide a light source by means of, e.g., a light-emitting diode (LED) or a cold cathode fluorescent lamp (CCFL); however, the present invention is not limited thereto. FIG. 2 shows a flowchart of a power consumption management method 20 for a backlight module according to an embodiment of the present invention. Referring to FIG. 1 and FIG. 2, the object detector 120 detects whether an object is present to generate an object detection signal S_{obj}. In one embodiment, the object detector 120 may be placed next to a display panel of the display device 10 to detect whether an object exists in front of the display panel. In one embodiment, the object detector 120 may be an infrared sensor, which determines that an object is present when an object temperature is greater than a temperature threshold and correspondingly generates the object detection signal S_{obj} to the power consumption management device 110. In another embodiment, the object detector 120 may be a proximity sensor, which determines that an object is present when a distance between the object and the proximity sensor is smaller than a distance threshold,. and correspondingly generates the object detection signal S_{obj} to the power consumption management device 110.

The power consumption management device 110 receives the object detection signal S_{obj} from the object detector 120 (step S210), and outputs, according to the object detection signal S_{obj} indicating the presence of the object, a control signal S1 to the image capturing unit 130 to control the image capturing unit 130 to capture an image IMG (step S220). In one embodiment, the image capturing unit 130 is a camera for capturing an image IMG in front of the display panel of the display device 10 to the power consumption management device 110. The power consumption management device 110 receives the image IMG from the image capturing unit 130 (step S230), and outputs a control signal S2 according to the image IMG to the backlight module 140 in order to control a power consumption of the backlight module 140 (step S240).

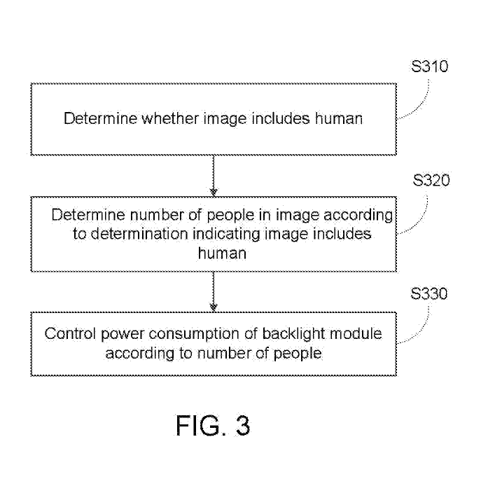

FIG. 3 shows detailed flowchart of step S240 of a power consumption management method for a backlight module according to an embodiment of the present invention. In one embodiment, the power consumption management device 110 first determines whether the image IMG includes a human (step S310). In one embodiment, the power consumption management device 110 may determine whether the image IMG includes a human by means of face recognition. More specifically, the power consumption management device 110 may perform, on the basis of color information in the image IMG, light compensation and color segmentation on the image IMG to acquire a skin-tone color range in the image IMG, and then perform image binarization to acquire a face block to determine whether the image IMG includes a human. In another embodiment, the power consumption management device 110 may perform differentiation on two adjacent images IMG to acquire motion information, capture a human body from a background according to the motion information, and perform human outer contour analysis by using the human skin-tone range as a filter to acquire a human body outer contour, thus determining whether the image includes a human.

The power consumption management device 110 further determines the number of people in the image IMG according to a determination result indicating the presence of a human (step S320). In one embodiment, the power consumption management device 110 may determine the number of people NP in the image IMG according to the number of human face blocks in the image IMG. For example, when the number of human face blocks in the image IMG is 5, the power consumption management device 110 determines that the number of people NP in the image IMG is 5. In another embodiment, the power consumption management device 110 may determine the number of people NP in the image IMG according to the number of human body outer contours in the image IMG. For example, when the number of human body outer contours in the image IMG is 5, the power consumption management device 110 determines that the number of people NP in the image IMG is 5.

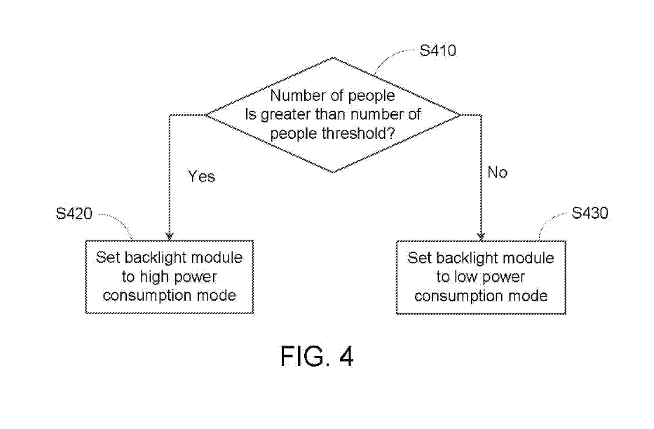

The power consumption management device 110 eventually controls the backlight module power consumption of the backlight module 140 according to the number of people NP in the image IMG (step S330). In one embodiment, the backlight module power consumption of the backlight module 140 is positively correlated with the number of people NP in the image IMG. In other words, the backlight module power consumption of the backlight module 140 increases as the number of people NP in the image IMG increases. The reason for the above is that, the larger the number of people is, the more likely the display device is used for watching a movie or playing games, and the color contrast and sharpness of an image display are more ideal for displaying a movie of game images as the backlight module gets brighter. For example, FIG. 4 shows a detailed flowchart of a power consumption management method for a backlight module according to an embodiment of the present invention. The power consumption management device 110 first determines whether the number of people NP is greater than a number of people threshold NPₜₕ (step S410). When the number of people NP is greater than the number of people threshold NPₜₕ, the power consumption management device 110 sets the backlight module of the backlight module 140 to a high power consumption mode (step S420). When the number of people NP is not greater than the number of people threshold NPₜₕ, the power consumption management device 110 sets the backlight module of the backlight module 140 to a low power consumption mode (step S430). Take NPₜₕ=1 for example, when the number of people NP is greater than NPₜₕ (e.g., NP=5), the power consumption management device 110 sets the backlight module of the backlight module 140 to a high power consumption mode; when the number of people NP is not greater than NPₜₕ (e.g., NP=1), the power consumption management device 110 sets the backlight module of the backlight module 140 to a low power consumption mode.

It should be noted that, the power consumption management device 110 in the above embodiment includes only one number of people threshold, but the present invention is not limited thereto. In other words, the power consumption management device 110 may include multiple number of people thresholds. For example, in another embodiment, the power consumption management module 110 may include two number of people thresholds NPₜₕ₁ and NPₜₕ₂. Take NPₜₕ₁=1 and NPₜₕ₂=3 for example, when the number of people NP is greater than NPₜₕ₂ (e.g., NP=5), the power consumption management module 110 sets the backlight module of the backlight module 140 to a high power consumption mode; when the number of people NP is between NPₜₕ₁ and NPₜₕ₂ (e.g., NP=2), the power consumption management module 110 sets the backlight module of the backlight module 140 to an intermediate power consumption mode; when the number of people NP is not greater than NPₜₕ₁ (e.g., NP=1), the power consumption management device 110 sets the backlight module of the backlight module 140 to a low power consumption mode.

In practice, the power consumption management module 110 may include one or more processors, and a memory storing instructions. The one or more processors controls, through executing the instructions stored in the memory, the power consumption management device 110 to perform the method as in FIG. 2, FIG. 3 and FIG. 4.

It should be noted that, in the above embodiments, the power consumption management module 110, the object detector 120 and the image capturing unit 130 are disposed in the display device 10, but the present invention is not limited thereto. For example, in another embodiment, the power consumption management module 110, the object detector 120 and the image capturing unit 130 may be disposed in an electronic device, which is coupled to the display device by wired or wireless means, such that the image capturing unit 130 may control the power consumption of the backlight module 140 of the display device 10 by wired or wireless means.

In summary, the present invention reduces the total power consumption of the display device by controlling the backlight module power consumption according to the number of people in an image, and it provides more significant power consumption effectiveness for large-size display devices. It should be noted that, compared to directly determining whether a human is included, the present invention first determines whether an object exists in front of the display panel of the backlight module 140 and then determines whether a human is included, thus reducing a computation amount.

While the invention has been described by way of example and in terms of the embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A power consumption management device for a backlight module, comprising:
one or more processor; and
a memory, storing instructions;
wherein, the one or more processors controls, by executing the instructions, the power consumption management device to:
receive an object detection signal from an object detector;
control an image capturing unit to capture an image according to the object detection signal;
receive the image from the image capturing unit; and
control a power consumption of the backlight according to the image.

2. The power consumption management device according to claim 1, wherein the step of controlling the power consumption of the backlight module according to the image comprises:
determining whether the image includes a human;
determining the number of people in the image according to a determination result indicating the image includes a human; and
controlling the power consumption of the backlight module according to the number of people.

3. The power consumption management device according to claim 1, wherein the power consumption of the backlight module is positively correlated with the number of people.

4. The power consumption management device according to claim 3, wherein the step of controlling the power consumption of the backlight module according to the number of people comprises:
determining whether the number of people is greater than a number of people threshold;
setting the backlight module to a high power consumption mode when the number of people is greater than the number of people threshold; and
setting the backlight module to a lower power consumption mode when the number of people is not greater than the number of people threshold.

5. The power consumption management device according to claim 1, wherein the object detector detects one or more objects to generate the object detection signal, and the control unit controls the image capturing unit to capture the image of the one or more objects according to the object detection signal.

6. The power consumption management device according to claim 1, wherein the object detector comprises an infrared sensor.

7. The power consumption management device according to claim 1, wherein the object detector comprises a proximity sensor.

8. A power consumption management method for a backlight module, comprising:
receiving an object detection signal from an object detector;
controlling an image capturing unit to capture an image according to the object detection signal;
receiving the image from the image capturing unit; and
controlling a power consumption of the backlight module according to the image.

9. The power consumption management method according to claim 8, wherein the step of controlling the power consumption of the backlight module according to the image comprises:
determining whether the image includes a human;
determining the number of people in the image according to a determination result indicating the image includes a human; and
controlling the power consumption of the backlight module according to the number of people.

10. The power consumption management method according to claim 9, wherein the power consumption of the backlight module is positively correlated with the number of people.

11. The power consumption management method according to claim 10, wherein the step of step of controlling the power consumption of the backlight module according to the number of people comprises:
determining whether the number of people is greater than a number of people threshold;
setting the backlight module to a high power consumption mode when the number of people is greater than the number of people threshold; and
setting the backlight module to a lower power consumption mode when the number of people is not greater than the number of people threshold.
